(19) United States
(12) Patent Application Publication
(10) Pub. No.: US 2025/0018724 A1
(43) Pub. Date: Jan. 16, 2025

(54) LIQUID EJECTION HEAD AND RECORDING DEVICE

(71) Applicant: CANON KABUSHIKI KAISHA, Tokyo (JP)

(72) Inventors: NORIYASU NAGAI, Tokyo (JP); NAOZUMI NABESHIMA, Tokyo (JP)

(21) Appl. No.: 18/754,786

(22) Filed: Jun. 26, 2024

(30) Foreign Application Priority Data
Jul. 10, 2023 (JP) 2023-113159

(51) Int. Cl. B41J 2/175; B41J 2/195

(52) U.S. Cl. CPC B41J 2/17596; B41J 2/195

(57) ABSTRACT

A liquid ejection head includes: a recording element substrate including an ejection port, an energy generation element which generates energy to eject liquid from the ejection port, a supply path which supplies liquid to the ejection port, and a collection path which collects liquid not ejected from the ejection port; and a pressure control unit controlling pressure of liquid inside the supply path to be positive pressure and pressure of liquid inside the collection path to be negative pressure, so that pressure of liquid in the ejection port becomes negative pressure.

### BACKGROUND OF THE INVENTION

### Field of the Invention

The present invention relates to a liquid ejection head, and a recording device equipped with the liquid ejection head.

### Description of the Related Art

An ejection port of a recording element substrate (hereafter may be called simply a “chip”) disposed on a liquid ejection head is open to the atmosphere, and the liquid forms meniscus at the ejection port portion by capillarity. Here to prevent leakage of the liquid through the ejection port, pressure applied to the liquid at the ejection port portion is normally controlled to be negative pressure (pressure lower than the pressure outside the liquid ejection head).

If negative pressure (an absolute value of the negative pressure) to be applied to the liquid at the ejection port portion is excessively large, the stability of forming ink droplets may deteriorate, resulting in the worsening of image quality. WO 05-075202 discloses a recording device which controls negative pressure to be applied to the liquid at the ejection port portion using a pressure control unit.

### SUMMARY OF THE INVENTION

In the above mentioned liquid ejection head, a channel, through which liquid flows passing near the ejection port portion of the recording element substrate, may be formed to prevent deterioration of the image quality caused by the thickening and adhesion of the liquid. In this case, in order to prevent the thickening and adhesion of the liquid effectively, it is preferable to increase a pressure difference of the liquid between the upstream side and the downstream side of the ejection port portion, and increase the flow speed of the liquid in an area near the ejection port. However, in order to increase the pressure difference of the liquid between the upstream side and downstream side of the ejection port portion, if the negative pressure of the liquid in the channel on the downstream side of the ejection port portion is excessively increased, the negative pressure of the liquid at the ejection port portion also increases, which may result in a drop in the image quality.

With the foregoing in view, it is an object of the present invention to provide a recording device which can prevent deterioration of the image quality.

In order to achieve the object described above, a liquid ejection head according to the present invention includes:
a recording element substrate including an ejection port, an energy generation element which generates energy to eject liquid from the ejection port, a supply path which supplies liquid to the ejection port, and a collection path which collects liquid not ejected from the ejection port; and
a pressure control unit controlling pressure of liquid inside the supply path to be positive pressure and pressure of liquid inside the collection path to be negative pressure so that pressure of liquid in the ejection port becomes negative pressure.

According to the present invention, a recording device which can prevent deterioration of the image quality can be provided.

Further features of the present invention will become apparent from the following description of exemplary embodiments with reference to the attached drawings.

### BRIEF DESCRIPTION OF THE DRAWINGS

FIG. 1 is a perspective view depicting a general configuration of a recording device according to an embodiment;

FIG. 2 is a schematic diagram depicting a circulation path of ink of the recording device according to the embodiment;

FIGS. 3A and 3B are schematic perspective views of a liquid ejection head according to the embodiment;

FIG. 4 is an exploded perspective view of the liquid ejection head according to the embodiment;

FIGS. 5A to 5C are explanatory diagrams of a channel member according to the embodiment;

FIGS. 6A and 6B are explanatory diagrams of channels of the channel member according to the embodiment;

FIGS. 7A and 7B are explanatory diagrams of an ejection module according to the embodiment;

FIGS. 8A to 8C are explanatory diagrams of a recording element substrate according to the embodiment;

FIG. 9 is a perspective view depicting a cross-section of the recording element substrate according to the embodiment;

FIGS. 10A to 10D are explanatory diagrams of a pressure adjustment mechanism according to the embodiment;

FIG. 11 is a graph depicting an example of a relationship between a valve opening and a valve resistance;

FIG. 12 is a side view of the liquid ejection head according to the embodiment;

FIG. 13 is a diagram depicting a configuration example of a negative pressure control unit according to the embodiment;

FIG. 14 is an explanatory diagram of a first configuration example of the negative pressure control unit;

FIG. 15 is an explanatory diagram of a second configuration example of the negative pressure control unit;

FIGS. 16A and 16B are explanatory diagrams of a third configuration example of the negative pressure control unit;

FIG. 17 is an explanatory diagram of a fourth configuration example of the negative pressure control unit;

FIG. 18 is an explanatory diagram of a fifth configuration example of the negative pressure control unit; and

FIG. 19 is an explanatory diagram of a modification of the negative pressure control unit.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

An embodiment of applying the present invention to a liquid ejection head (inkjet head), which ejects such liquid as ink by a thermal method, will be described. The thermal method is a method of ejecting liquid by generating bubbles using heating elements disposed on a liquid ejection head. The present invention, however, is not limited to the thermal type liquid ejection head, but may be applied to a piezo type and various other liquid ejection type liquid ejection heads.

In the following embodiment, an inkjet recording device is configured such that the liquid (ink) circulates between and a tank and a liquid ejection head. However, it may be configured, for example, that two tanks are disposed at the upstream side and downstream side of the liquid ejection head without circulating the ink, so that ink flows from one tank to the other tank, whereby ink flows inside a pressure chamber.

The liquid ejection head of this embodiment is a line type head having a length corresponding to a width of a recording medium to be used. However, the present invention can also be applied to a serial type liquid ejection head, which performs recording while scanning a recording medium. The serial type liquid ejection head, for example, has a configuration where one recording element substrate is disposed for black ink and each color ink respectively, but the present invention is not limited to this. For example, a line head of which length is shorter than the width of the recording medium is created by disposing several recording element substrates in the ejection port row direction such that the ejection ports overlap, and the recording medium is scanned with this line head.

### Embodiment

### Inkjet Recording Device

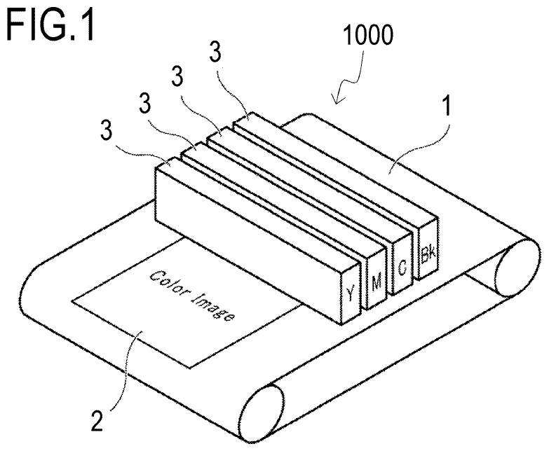

A recording device 1000 of an embodiment of the present invention will be described. FIG. 1 is a perspective view depicting a general configuration of the recording device 1000. The recording device 1000 is a device to eject liquid, and in particular is an inkjet recording device which ejects ink and performs recording thereby.

The recording device 1000 includes a conveying portion 1 which conveys recording medium 2, and four line type liquid ejection heads 3. Each liquid ejection head 3 is disposed such that the longitudinal direction thereof becomes approximately orthogonal with a conveying direction of a recording medium 2. The recording device 1000 is a line type recording device which performs continuous recording by one path while continuously or intermittently conveying a plurality of recording media 2. The recording medium 2 is not limited to cut paper, but may be continuous roll paper. Further, the recording medium 2 is not limited to paper, but may be film or the like.

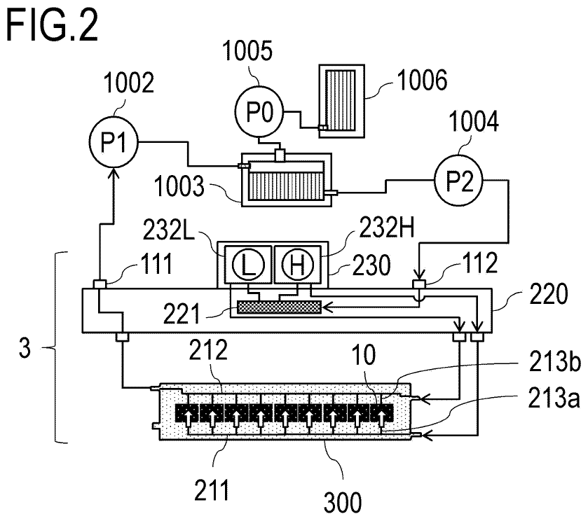

Each of the four liquid ejection heads 3 are configured to eject one of four colors of ink, CMYK (cyan, magenta, yellow and black) respectively, and the recording device 1000 can perform full color printing. To each of the liquid ejection head 3, an ink channel to supply ink to this liquid ejection head 3, is connected, and is fluidly connected to a main tank 1006 and a buffer tank 1003 (see FIG. 2) via the ink channel. Further, to the liquid ejection head 3, an electric control unit, which transmits power and an ejection control signal to the liquid ejection head 3, is electrically connected. Details on the liquid path and the electric signal path of the liquid ejection head 3 will be described in detail later.

### Ink Circulation System

An ink circulation system in the recording device 1000 will be described next. FIG. 2 is a schematic diagram depicting a circulation path of the ink, that is applied to the recording device 1000. The liquid ejection head 3 is fluidly connected to a first circulation pump 1002 via a liquid connection portion 111, and is fluidly connected to a second circulation pump 1004 via a liquid connection portion 112. The first circulation pump 1002 and the second circulation pump 1004 are fluidly connected to the buffer tank 1003 respectively. In the recording device 1000 of this embodiment, the ink flows sequentially circulating through the liquid ejection head 3, the first circulation pump 1002, the buffer tank 1003 and the second circulation pump 1004. In FIG. 2, only a path where one color of ink, out of CMYK, flows is indicated to simplify explanation, but actually in the recording device 1000, ink circulation paths for four colors of ink are disposed.

The buffer tank 1003 is a sub-tank that is fluidly connected to the main tank 1006 via a replenishing pump 1005. The buffer tank 1003 includes an atmosphere communication hole through which the inside and outside of the tank communicate, whereby bubbles in the ink can be discharged to the outside. In the case where the ink is ejected (discharged) through the ejection port of the liquid ejection head 3, and the ink is consumed by the liquid ejection head 3 due to the recording operation, suction recovery and the like, the replenishing pump 1005 supplies the amount of the consumed ink from the main tank 1006 to the buffer tank 1003.

The first circulation pump 1002 has a role to draw the ink inside the liquid ejection head 3 via the liquid connection portion 111 of the liquid ejection head 3, and supply the ink to the buffer tank 1003. When the liquid ejection head 3 is driven, a predetermined amount of ink flows inside a common collection channel 212 of the liquid ejection head 3 by the first circulation pump 1002. The common collection channel 212 of the liquid ejection head 3 will be described in detail later.

The second circulation pump 1004 has a role to supply the ink from the buffer tank 1003 to the liquid connection portion 112 of the liquid ejection head 3. Thus in the recording device 1000 of this embodiment, the ink circulates between the liquid ejection head 3 and the buffer tank 1003 by the first circulation pump 1002 and the second circulation pump 1004.

The liquid ejection head 3 is constituted of a liquid supply unit 220, a negative pressure control unit 230, and a liquid ejection unit 300. The ink channel inside the liquid ejection head 3 is constituted of each channel formed in each of the units. In this embodiment, the negative pressure control unit 230 is included in the liquid ejection head 3, but when the present invention is applied, the negative pressure control unit 230 may be disposed separately from the liquid ejection head 3.

In the liquid supply unit 220, the liquid connection portion 111 which is connected to the first circulation pump 1002, and the liquid connection portion 112 which is connected to the second circulation pump 1004, are disposed. Further, inside the liquid supply unit 220, a filter 221, to remove foreign substances in the ink to be supplied, is disposed. In this embodiment, the filter 221 is disposed for each ink color, and is disposed at a position communicating with an opening of the liquid connection portion 112.

The negative pressure control unit 230 is a pressure control unit (pressure control means) which controls the pressure of the ink to be supplied to the liquid ejection unit 300. The negative pressure control unit 230 is disposed on the ink path between the second circulation pump 1004 and the liquid ejection unit 300. In a case where the flow rate of the circulation system changes due to the difference in Duty for recording, the negative pressure control unit 230 plays a function of operating to maintain the pressure on the downstream side of the negative pressure control unit 230 (on the side of the liquid ejection unit 300) at a predetermined pressure which is set in advance.

In an area near the ejection port of the liquid ejection head 3, negative pressure is applied to the ink, and meniscus is formed inside the ejection port to prevent leakage of the ink. If the negative pressure of the ink changes, the meniscus surface position inside the ejection port changes, and the volume of ink droplets to be ejected also changes. If the volume of droplets largely changes, image quality (print quality) may deteriorate due to the generation of uneven image density and the like. Furthermore, If the negative pressure at the ejection port is excessively high, the meniscus surface position may significantly change, then forming ink droplets to be ejected may become unstable, and image quality (print quality) may deteriorate thereby. Therefore in this embodiment, the negative pressure control unit 230 maintains the pressure of the ink to be supplied to the liquid ejection unit 300, including the ejection port, to be constant.

The negative pressure here refers to a pressure difference from the atmospheric temperature when this pressure is lower than the atmospheric pressure. In the following description, “negative pressure is large” means that a difference from the atmospheric pressure is large, and the absolute value of the pressure is large. “Positive pressure” refers to a pressure difference from the atmospheric pressure when this pressure is higher than the atmospheric pressure.

As indicated in FIG. 2, the negative pressure control unit 230 includes two pressure adjustment mechanisms 232 (negative pressure adjustment mechanisms), in which the control pressures of the ink are set differently from each other. In the following, the two pressure adjustment mechanisms 232 will be described separately as: a first pressure adjustment mechanism 232H where the control pressure is set to a relatively high pressure; and a second pressure adjustment mechanism 232L where the control pressure is set to a relatively low pressure. The control pressures of the first pressure adjustment mechanism 232H and the second pressure adjustment mechanism 232L are both negative pressures, and the negative pressure control unit 230 is configured such that the negative pressure in the first pressure adjustment mechanism 232H is smaller than the negative pressure in the second pressure adjustment mechanism 232L.

The first pressure adjustment mechanism 232H is connected to a common supply channel 211, which is disposed inside the liquid ejection unit 300, via the liquid supply unit 220. The second pressure adjustment mechanism 232L is connected to a common collection channel 212, which is disposed inside the liquid ejection unit 300, via the liquid supply unit 220.

In this embodiment, a single channel is formed from the liquid connection portion 112 to the filter 221, and the channel is divided on the downstream side of the filter 221. One of the divided channels is connected to the first pressure adjustment mechanism 232H, and the other thereof is connected to the second pressure adjustment mechanism 232L. In other words, a part of the ink which passed through the filter 221 is adjusted to a relatively high pressure by the first pressure adjustment mechanism 232H, and flows into the common supply channel 211, and the rest of the ink is adjusted to a relatively low pressure by the second pressure adjustment mechanism 232L, and flows into the common collection channel 212.

In the liquid ejection unit 300, the common supply channel 211, the common collection channel 212, and a plurality of recording element substrates 10 are disposed. On each one of the recording element substrates 10, an individual supply channel 213a which communicates with the common supply channel 211, and an individual collection channel 213b which communicates with the common collection channel 212 are disposed. Because of this channel configuration, a flow of ink from the common supply channel 211 to the common collection channel 212 through the inner channels of the recording element substrates 10 (arrows in FIG. 2) is generated inside the liquid ejection unit 300. The first pressure adjustment mechanism 232H is connected to the common supply channel 211, and the second pressure adjustment mechanism 232L is connected to the common collection channel 212. Because of these pressure adjustment mechanisms 232, a differential pressure is generated between the common supply channel 211 and the common collection channel 212, therefore the flow of ink from the common supply channel 211 to the common collection channel 212 is generated. During the recording operation, a part of the ink which flows into the common supply channel 211 is ejected through the ejection port formed on the recording element substrate 10, and the rest of the ink flows into the common collection channel 212.

Because of the configuration described above, while the ink is flowing through the common supply channel 211 and the common collection channel 212 in the liquid ejection unit 300, part of the ink flows passing through the inside of each recording element substrate 10. By the ink flowing from the common supply channel 211 to the common collection channel 212 via the recording element substrates 10, heat generated in the recording element substrates 10 can be discharged out of the recording element substrates 10. Further, because of this configuration, the flow of ink can also be generated in an ejection port and a pressure chamber which are not used for recording, while recording is performed by the liquid ejection head 3, hence the thickening and adhesion of the ink in these areas can be prevented. Furthermore, the thickened ink and the foreign substances in the ink can be discharged to the common collection channel 212. In other words, according to the liquid ejection head 3 of this embodiment, deterioration of the image quality can be prevented, and high image quality recording can be implemented at high-speed.

The above mentioned two pressure adjustment mechanisms 232 disposed inside the negative pressure control unit 230 need not always be controlled to be negative pressures, but are preferably controlled to be pressures with which the negative pressure is maintained at the ejection ports of the recording element substrates 10. In order to more accurately control the pressure values at the ejection ports, the fluctuation of the pressure in the channels from the pressure adjustment mechanisms 232 to the ejection ports must be controlled, hence it is preferable that the pressure adjustment mechanisms 232 are disposed at positions close to the ejection ports. Therefore in order to perform accurate pressure control, the negative pressure control unit 230 is preferably disposed on the liquid ejection head 3, as described in this embodiment.

The negative pressure control unit 230 and the liquid supply unit 220 indicated in FIG. 2 constitute a pressure control assembly. To implement high image quality printing, it is necessary to maintain the pressure difference by preventing fluctuation of the pressure loss generated in the channels from the two pressure adjustment mechanisms 232 to the ejection ports, and to stabilize the circulation flow speed of the liquid flowing through the ejection ports. Therefore it is preferable to dispose the negative pressure control unit 230 on the liquid ejection head 3 to shorten the channel length from the pressure adjustment mechanism 232 to the ejection ports, and reduce the pressure loss thereby.

In this embodiment, the common filter 221 is disposed on the upstream side of the first pressure adjustment mechanism 232H and the second pressure adjustment mechanism 232L. In this configuration, pressure loss can be reduced compared with a configuration where respective filters are disposed on the downstream side of the first pressure adjustment mechanism 232H and the second pressure adjustment mechanism 232L respectively. Further, it can be prevented that the negative pressure (absolute value of the negative pressure) of the ink at the ejection ports of the recording element substrates 10 becomes excessively large, hence deterioration of the image quality can be prevented.

### Liquid Ejection Head

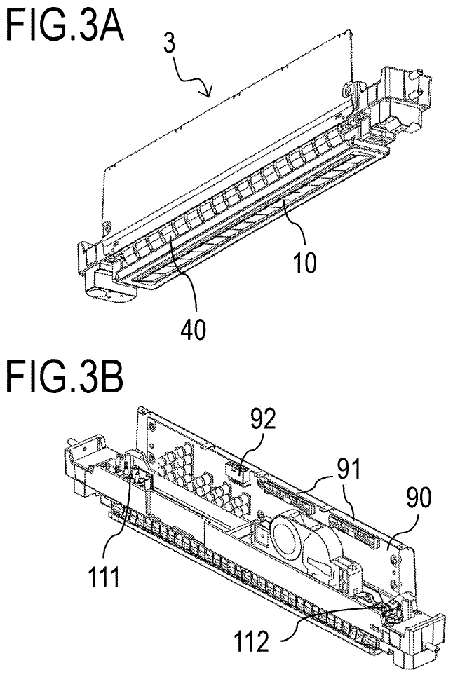

A configuration of the liquid ejection head 3 according to this embodiment will be described next. FIGS. 3A and 3B are perspective views of the liquid ejection head 3 according to this embodiment. FIG. 3A is a state of viewing the liquid ejection head 3 from the lower side where the recording element substrates 10 are disposed, and FIG. 3B is a state of viewing the liquid ejection head 3 from the upper side. The liquid ejection head 3 is a line type liquid ejection head on which seventeen recording element substrates 10 are linearly disposed (in-line arrangement).

The liquid ejection head 3 includes a plurality of flexible wiring boards 40 and an electric wiring board 90. As indicated in FIG. 3A, on the liquid ejection head 3, a plurality of recording element substrates 10 and a same number of flexible wiring boards 40 are disposed, and one flexible wiring board 40 is connected to one recording element substrate 10.

In the liquid ejection head 3, signal input terminals 91 and power supply terminals 92, which are electrically connected to each recording element substrate 10, are disposed via the flexible wiring boards 40 and the electric wiring board 90. The signal input terminals 91 and the power supply terminals 92 are electrically connected to a control portion of the recording device 1000. The signal input terminals 91 supply an ejection driving signal to the recording element substrates 10, and the power supply terminals 92 supply power required for ink ejection to the recording element substrates 10. By consolidating the wires in the electric wiring board 90 by an electric circuit, a number of the signal input terminals 91 and a number of power supply terminals 92 can be decreased compared with a number of recording element substrates 10. By this configuration, when assembly or replacement of the liquid ejection head 3 is required for the recording device 1000, a number of electric connection portions to be connected or disconnected becomes less, and work efficiency improves.

As indicated in FIG. 3B, the liquid connection portion 111 disposed on one end of the liquid ejection head 3 in the longitudinal direction and the liquid connection portion 112 disposed on the other end thereof are connected to a liquid supply system of the recording device 1000. By this configuration, four colors of ink (CMYK) are supplied from the supply system of the recording device 1000 to the liquid ejection head 3, and the ink passed through the liquid ejection head 3 is collected into the supply system of the recording device 1000. In this way, the ink of each color can circulate via the ink channel of the recording device 1000 and the ink channel of the liquid ejection head 3.

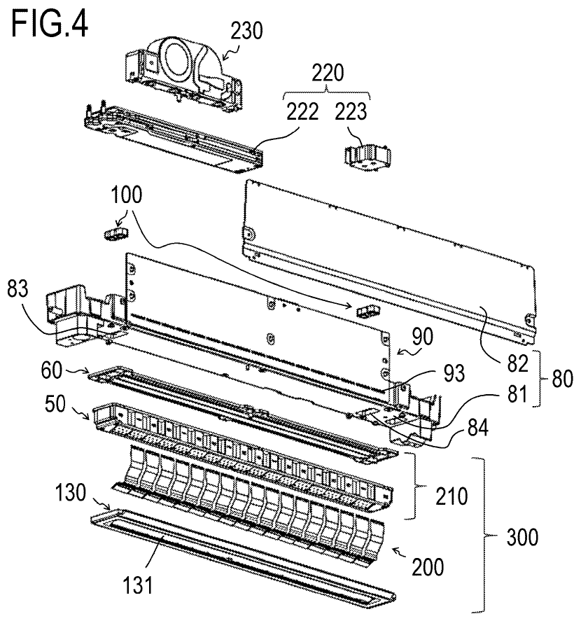

FIG. 4 is an exploded perspective view of the liquid ejection head 3, and indicates components and units constituting the liquid ejection head 3. In this embodiment, the liquid ejection unit 300, the liquid supply unit 220 and the electric wiring board 90 are installed in a casing 80.

The liquid supply unit 220 is constituted of a filter box 222 in which the filter 221 is installed, and an ink connector 223. In the filter box 222, the negative pressure control unit 230 is installed, and the ink passing through the filter 221 is supplied from the filter box 222 to the negative pressure control unit 230. The filter box 222 and the ink connector 223 are installed in the casing 80 in a state of holding a joint rubber 100 respectively in a space with the casing 80.

The negative pressure control unit 230 is a unit which includes a pressure regulating valve. The negative pressure control unit 230 considerably attenuates pressure loss change in the supply system of the recording device 1000 (supply system on the upstream side of the liquid ejection head 3) generated by fluctuation of the flow rate of the liquid due to the functions of the valves and the spring members disposed inside the negative pressure control unit 230. Further, the negative pressure control unit 230 can stabilize the negative pressure change on the downstream side (liquid ejection unit 300 side) of the negative pressure control unit 230 to be within a predetermined range.

Inside the negative pressure control unit 230 of each color, the first pressure adjustment mechanism 232H and the second pressure adjustment mechanism 232L are included, and each pressure adjustment mechanism 232 includes a pressure regulating valve. The first pressure adjustment mechanism 232H and the second pressure adjustment mechanism 232L are set to mutually different control pressures. The first pressure adjustment mechanism 232H on the high pressure side communicates with the common supply channel 211 inside the liquid ejection unit 300 via the liquid supply unit 220. The second pressure adjustment mechanism 232L on the low pressure side communicates with the common collection channel 212 inside the liquid ejection unit 300 via the liquid supply unit 220.

The casing 80 supports the liquid ejection unit 300 and the electric wiring board 90, so as to ensure rigidity of the liquid ejection head 3. The casing 80 is constituted of a liquid ejection unit support portion 81 and an electric wiring board support portion 82. The electric wiring board support portion 82 is a support portion to support the electric wiring board 90, and is fixed to the liquid ejection unit support portion 81 by screws. FIG. 4 indicates a state where the liquid ejection unit support portion 81 and the electric wiring board support portion 82 are separated.

The liquid ejection unit support portion 81 plays a role of ensuring the relative positional accuracy of the plurality of recording element substrates 10, correcting warp and deformation of the liquid ejection unit 300, so as to prevent lines and non-uniformity on a recording material. Therefore it is preferable that the liquid ejection unit support portion 81 has sufficient rigidity, and a material thereof is a metal material (e.g. SUS, aluminum) or ceramic (e.g. alumina). In the liquid ejection unit support portion 81, openings 83 and 84, to insert joint rubbers 100, are formed. Through the joint rubbers 100, the ink supplied from the liquid supply unit 220 is guided to a second channel member 60 constituting the liquid ejection unit 300.

On the electric wiring board 90, a plurality of connection terminals 93 are disposed, which are electrically connected to ejection modules 200 including the flexible wiring boards 40. In this embodiment, one connection terminal 93 is disposed for one ejection module 200.

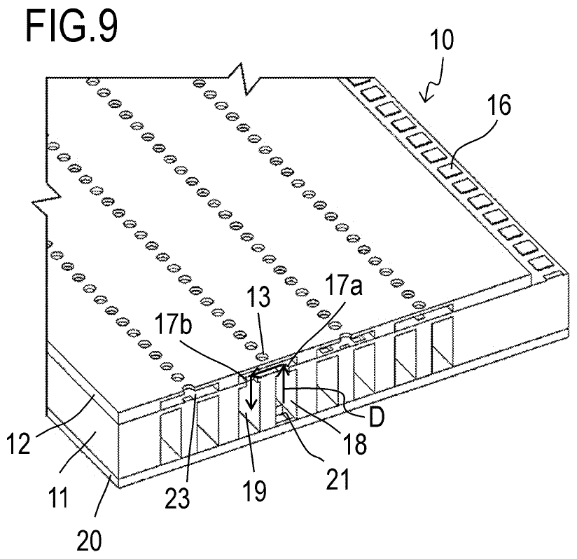

The liquid ejection unit 300 is constituted of the plurality of ejection modules 200 and a channel member 210, and a cover member 130 is installed on a surface of the liquid ejection unit 300 on the side of the recording medium. As illustrated in FIG. 4, the cover member 130 is a member having a frame type surface where a long opening 131 is formed in the longitudinal direction of the liquid ejection head 3. In a state where the liquid ejection unit 300 is assembled, the recording element substrates 10 included in the ejection modules 200 and a sealing material 110 (see FIG. 9) are exposed from the opening 131. The frame portion surrounding the opening 131 plays a function of a contact surface of a cap member, which caps the liquid ejection head 3 in the recording standby state. It is preferable that an adhesive, a sealing material, a filling material and the like are coated around the opening 131, so as to fill in the roughness and gaps on the ejection port surface of the liquid ejection unit 300, thereby a closed space can be formed in the liquid ejection head 3 when capped.

A configuration of the channel member 210 included in the liquid ejection unit 300 will be described next. The channel member 210 is constituted of a first channel member 50 and the second channel member 60, which are layered. On the bonding surface of the first channel member 50, the plurality of ejection modules 200 are bonded by adhesive. The channel formed inside the channel member 210 is configured such that the ink supplied from the liquid supply unit 220 is distributed to each of the ejection modules 200, and the ink circulated from the ejection module 200 is returned to the liquid supply unit 220. The channel member 210 is fixed to the liquid ejection unit support portion 81 by screws.

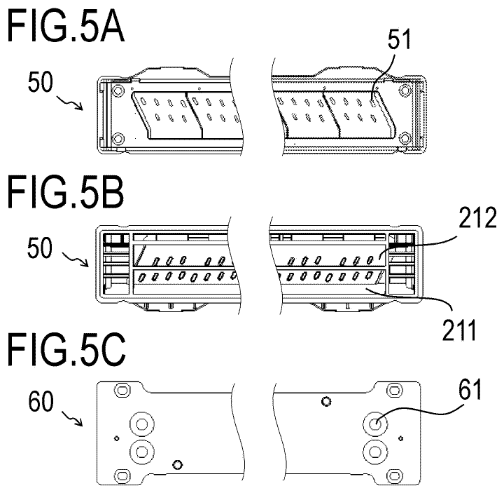

FIGS. 5A to 5C are explanatory diagrams of the channel member 210, and indicate a detailed configuration of the first channel member 50 and the second channel member 60 constituting the channel member 210. FIG. 5A indicates a front surface (contact surface with the recording element substrates 10) of the first channel member 50. FIG. 5B indicates a rear surface (contact surface with the second channel member 60) of the first channel member 50. FIG. 5C indicates a rear surface (contact surface with the first channel member 50) of the second channel member 60.

On the surface of the first channel member 50, a plurality of communication ports 51 are arrayed. The communication ports 51 are regularly arrayed in the longitudinal direction of the liquid ejection head 3. A group of the communication ports 51, which form a repeat pattern of the communication ports 51, corresponds to one recording element substrate 10. The communication port 51 is an opening that is fluidly connected with the recording element substrate 10, and is a composing element of the individual supply channel 213a and the individual collection channel 213b.

In the second channel member 60, a common channel groove which extends in the longitudinal direction of the liquid ejection head 3, and common communication ports 61 which are located on both ends of the second channel member 60 and communicate with the common channel groove, are formed. The common communication ports 61 are formed on the bottom surface of the common channel groove, and fluidly communicate with the liquid supply unit 220.

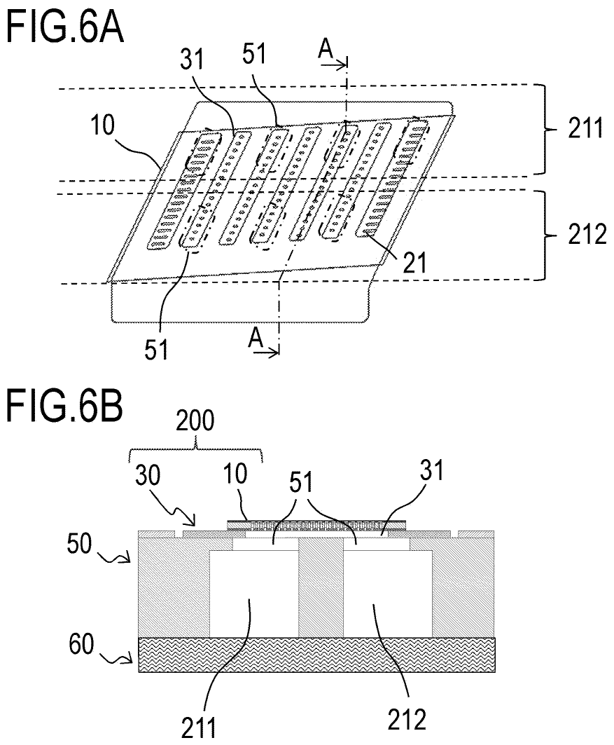

FIGS. 6A and 6B are explanatory diagrams of channels formed inside the channel member 210. FIG. 6A indicates a channel structure when the channel member 210 is viewed in the opening direction of the communication ports 51. FIG. 6B is cross-sectional view sectioned at A-A in FIG. 6A, and indicates a channel structure when the channel member 210 is viewed in a direction vertical to the opening direction of the communication ports 51.

Inside the first channel member 50, the common supply channel 211 and the common collection channel 212 are extended in the longitudinal direction. In FIG. 6A, relative positions of the common supply channel 211 and the common collection channel 212, with respect to the recording element substrates 10, are indicated by dotted lines. The common supply channel 211 and the common collection channel 212 are fluidly connected with the openings 21 of the recording element substrate 10 via the communication ports 51 of the first channel member 50 and the communication ports 31 of a support member 30. The support member 30 is a composing element of the ejection module 200, and will be described in detail later.

As described above, the common supply channel 211 is connected to the first pressure adjustment mechanism 232H of which setting pressure is relatively high, and the common collection channels 212 is connected to the second pressure adjustment mechanism 232L of which setting pressure is relatively low. In this embodiment, the ink supply path, to supply ink to the recording element substrate 10, is constituted of a common communication port 61, the common supply channel 211, and the individual supply channel 213a which includes the communication ports 51. The pressure of the ink which passes through the ink supply path is adjusted mainly by the first pressure adjustment mechanism 232H. The ink collection path to collect ink from the recording element substrates 10, on the other hand, is constituted of the individual collection channel 213b which includes the communication ports 51, the common collection channel 212, and the common communication port 61. The pressure of the ink which passes through the ink collection path is adjusted mainly by the second pressure adjustment mechanism 232L. When the ejection operation in accordance with the ejection data is performed in the recording element substrate 10, the ink which was not consumed by the ejection operation, out of the ink supplied by the ink supply path, is collected to the ink collection path, and is circulated.

### Ejection Module

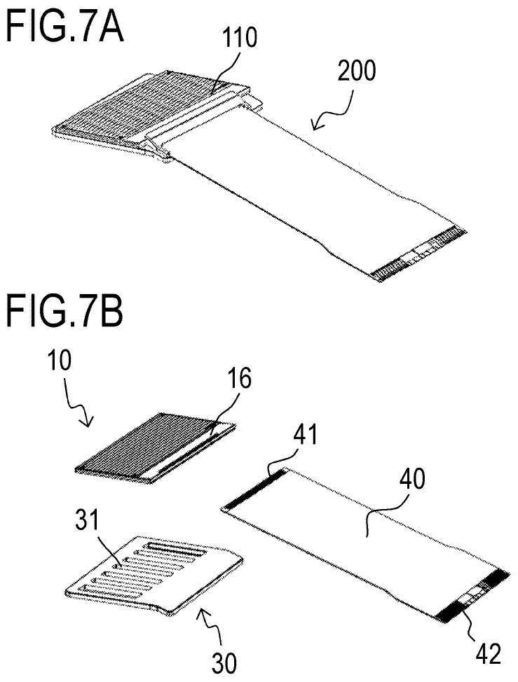

The configuration of the ejection module 200 will be described in detail next. FIGS. 7A and 7B are explanatory diagrams of the ejection module 200. FIG. 7A is a perspective view of the ejection module 200 in an assembled state, and FIG. 7B is an exploded perspective view of the ejection module 200. The ejection module 200 is constituted of the recording element substrate 10, the support member 30 that supports the recording element substrate 10, and the flexible wiring board 40, for electrically connecting the recording element substrate 10 to the electric wiring board 90.

A terminal 16 is disposed on the recording element substrate 10. On one end of the flexible wiring board 40, a terminal 41 which is electrically connected with the terminal 16 is disposed, and on the other end, a terminal 42 which is electrically connected with the connection terminal 93 of the electric wiring board 90 (see FIG. 4) is disposed.

A method for manufacturing the ejection module 200 will be described. First the recording element substrate 10 and the flexible wiring board 40 are bonded on the support member 30. Then the terminal 16 on the recording element substrate 10 and the terminal 41 on the flexible wiring board 40 are electrically connected by wire bonding, and the wire bonding portion (electric connection portion) is covered with the sealing material 110, so as to be sealed. The terminal 41 on the flexible wiring board 40 and the terminal 42 disposed on an edge, on the opposite side of the edge connected with the recording element substrate 10, are electrically connected with the connection terminal 93 of the electric wiring board 90.

The support member 30 is not only a support member to support the recording element substrate 10, but also a channel member allowing the recording element substrate 10 and the channel member 210 to fluidly communicate with each other, hence it is preferable that the support member 30 has a high flatness, and can be bonded with the recording element substrate 10 with sufficiently high reliability. Therefore the material of the support member 30 is preferably alumina or a resin material, for example.

### Recording Element Substrate

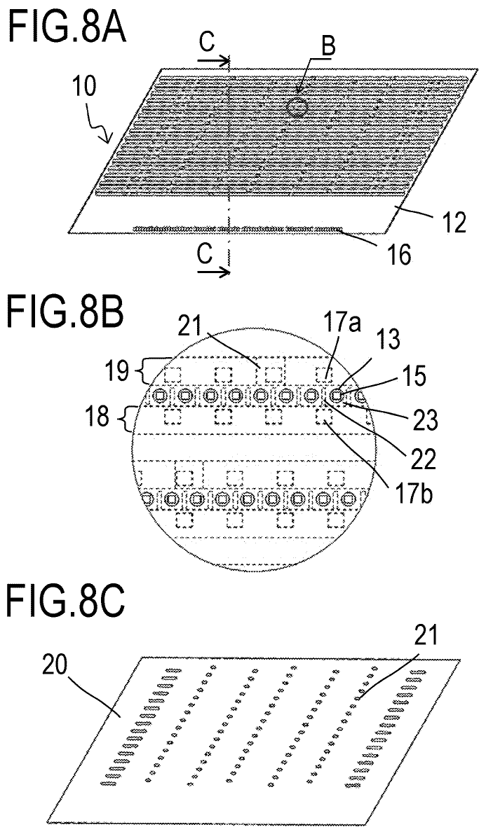

The configuration of the recording element substrate 10 will be described in detail next. FIGS. 8A to 8C are explanatory diagrams of the recording element substrate 10 according to this embodiment. FIG. 8A indicates a surface of the recording element substrate 10 on the side where ejection ports 13 are formed. FIG. 8B is an enlarged view of a B portion indicated in FIG. 8A. FIG. 8C indicates a rear surface of the surface indicated in FIG. 8A. The configuration of the recording element substrate 10, indicated in FIGS. 8A to 8C, is merely a configuration example. To apply the present invention, the row of the ejection ports formed on an ejection port forming member 12 of the recording element substrate 10 may be more or less than the number of ejection ports indicated in FIG. 8A, for example. In the following description, a direction in which the ejection port row, where a plurality of ejection ports 13 are arrayed in a line, is called an “ejection port row direction”.

As illustrated in FIG. 8B, a recording element 15, which is a heating element (energy generation element) to foam ink by generating thermal energy, is disposed at a position corresponding to each ejection port 13. On the recording element substrate 10, a plurality of pressure chambers 23, each of which encloses the recording element 15, are demarcated by a barrier 22.

The recording element 15 is electrically connected to the terminal 16 by an electric wiring formed on the recording element substrate 10. The recording element 15 heats up based on pulse signals which are inputted from the control circuit of the recording device 1000 via the electric wiring board 90 (see FIGS. 5A to 5C) and the flexible wiring board 40, and boils the ink thereby. Using the force of the foaming generated by this boiling, the recording element substrate 10 ejects the ink through the ejection port 13.

As illustrated in FIG. 8B, on the recording element substrate 10, a supply path 18 and a collection path 19 extend along each ejection port row. The supply path 18 and the collection path 19 are channels which are disposed sandwiching the ejection port row, and extend in the ejection port row direction. The supply path 18 communicates with each ejection port 13 (pressure chamber 23) via a supply port 17a, and the collection path 19 communicates with each ejection port 13 (pressure chamber 23) via a collection port 17b.

As illustrated in FIG. 8C, a sheet type cover plate 20 is layered on the rear surface of the recording element substrate 10 (opposite surface of the surface where ejection ports 13 are formed). In the cover plate 20, which is a cover member, a plurality of openings 21, which communicate with the supply path 18 and the collection path 19, are formed. In this embodiment, in the cover plate 20, three openings 21 are formed for each supply path 18, and two openings are formed for each collection path 19, but application of the present invention is not limited to this. Each of the openings 21 of the cover plate 20 communicates with any one of the plurality of communication ports 51 indicated in FIG. 6C.

It is preferable that the cover plate 20 has sufficient corrosion resistance to ink. In terms of preventing the mixing of colors of ink, high accuracy is demanded for the opening shape and the opening position of each opening 21. Therefore it is preferable to form the openings 21 by a photolithography process using a photosensitive resin material or silicon for the material of the cover plate 20.

The flow of the ink in the recording element substrate 10 will be described next with reference to FIG. 9. FIG. 9 is a perspective view depicting a cross-section of the recording element substrate 10 (cross-section at C-C in FIG. 8A), and indicates the channel configuration of the recording element substrate 10. The cover plate 20 has a function of a cover which constitutes a part of the walls of the supply path 18 and the collection path 19 formed on the substrate 11 of the recording element substrate 10.

The recording element substrate 10 is constituted of the substrate 11 formed of Si and the ejection port forming member 12 formed of a photosensitive resin, which are layered. The cover plate 20 is bonded to the rear surface of the substrate 11 (opposite surface of the surface connected with the ejection port forming member 12). The recording element 15 is formed on the surface of the substrate 11 on the side of the ejection port forming member 12. On the surface of the substrate 11 on the side of the cover plate 20, grooves constituting the supply path 18 and the collection path 19 extending along the ejection port row are formed.

The supply path 18 and the collection path 19 are formed by the substrate 11 and the cover plate 20, and the former is connected to the common supply channel 211 in the channel member 210, and the latter is connected to the common collection channel 212 in the channel member 210. As described above, the first pressure adjustment mechanism 232H is connected to the common supply channel 211, and the second pressure adjustment mechanism 232L is connected to the common collection channel 212, hence a differential pressure is generated between the supply path 18 and the collection path 19.

Because of the generation of the differential pressure, when the recording is being performed with the ejecting ink from the ejection ports 13, the ink inside the supply path 18 flows to the collection path 19 via the supply port 17a, the pressure chamber 23 and the collection port 17b in the channel corresponding to each ejection port 13 where the ejection operation is not performed. In FIG. 9, the flow direction of the ink is indicated by the arrow mark D. Since the ink flows even in the channel corresponding to each ejection port 13 where the ejection operation is not performed like this, the thickened ink, bubbles, foreign substances and the like, generated by evaporation from the ejection port 13, can be collected to the collection path 19. Further, thickening of the ink at the ejection port 13 and the pressure chamber 23 thickens or increase of the density of the color material can be prevented.

The ink collected to the collection path 19 sequentially passes through the opening 21 of the cover plate 20, the communication port 31 of the support member 30, the communication port 51 of the first channel member 50, and the common collection channel 212, and is collected to the ink path of the recording device 1000.

### Pressure Adjustment Mechanism

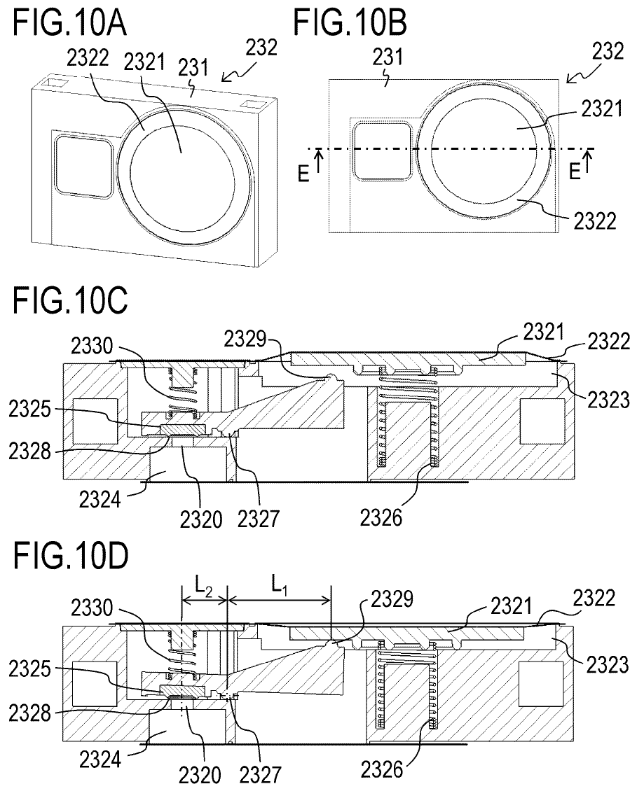

The pressure adjustment mechanism 232 will be described in detail next. FIGS. 10A to 10D are diagrams depicting a structure of the pressure adjustment mechanism 232 according to this embodiment. FIG. 10A is a perspective view depicting an appearance of the pressure adjustment mechanism 232. FIG. 10B is a plan view depicting an appearance of the pressure adjustment mechanism 232. FIG. 10C and FIG. 10D are cross-sectional views at E-E in FIG. 10B. FIG. 10C indicates a state where a movable valve 2325 is closed, and pressure adjustment by a pressure reducing valve is not performed. FIG. 10D indicates a state where the movable valve 2325 is open, and pressure adjustment by the pressure reducing valve is performed. The operation principle of the pressure adjustment mechanism 232 is the same as that of the so called “pressure reducing regulator”.

The pressure adjustment mechanism 232 is a pressure reducing valve which adjusts pressure by reducing the pressure of the ink that flows inside. Inside the casing 231 of the pressure adjustment mechanism 232, a pressure chamber 2323, an orifice 2320, and a liquid circulation chamber 2324, which communicates with the orifice 2320, are formed. The pressure adjustment mechanism 232 includes a pressure receiving plate 2321 which functions as a pressure receiving portion, a flexible film 2322 which fluidly seals the pressure receiving plate 2321 and the casing 231, the movable valve 2325 which opens/closes the orifice 2320, a spring 2326 and a spring 2330. The orifice 2320 is disposed on the upstream side of the pressure chamber 2323 in the ink flow direction, and is configured to be opened/closed by the movable valve 2325 which is a valve element.

The movable valve 2325 is a lever member configured to be able to rotate (oscillate) around a rotation shaft 2327. The rotation shaft 2327 extends in the direction perpendicular to the paper surface in FIG. 10C, and the movable valve 2325 is configured to be able to rotate clockwise and counterclockwise in FIG. 10C. By the spring 2330, the movable valve 2325 is urged in a direction of moving from a portion to open the orifice 2320 to a position to close the orifice 2320 (in a down direction n FIG. 10C).

In the movable valve 2325, a closing portion 2328, to close a gap with the orifice 2320, is disposed on one end side in a direction perpendicular to the axial direction of the rotation shaft 2327, and a contact portion 2329, to contact with the pressure receiving plate 2321, is disposed on the other end side. The rotation shaft 2327 is located between the closing portion 2328 and the contact portion 2329, and is supported by the casing 231. The contact portion 2329 is disposed to be contactable with the pressure receiving plate 2321 inside the pressure chamber 2323. The movable valve 2325 is disposed on the downstream side of the orifice 2320 in the ink flow direction, and opens/closes the orifice 2320.

The pressure receiving plate 2321 is configured to be movable by the pressure difference between the pressure chamber 2323 and outside the casing 231. The pressure receiving plate 2321 is also urged by the spring 2326 in the direction of departing from the contact portion 2329 of the movable valve 2325 (up direction in FIG. 10C). In this embodiment, the urging direction of the spring 2326 and the urging direction of the spring 2330 are opposite from each other. By these urging members, the movable valve 2325 normally contacts with an area of the casing 231 near the orifice 2320, as indicated in FIG. 10C, so as to close the gap from the casing 231 and keep the orifice 2320 in the closed state.

When the pressure receiving plate 2321 moves in a direction toward the movable valve 2325 (down direction in FIG. 10C), so as to reduce the volume of the pressure chamber 2323, the pressure receiving plate 2321 contacts the contact portion 2329 of the movable valve 2325. If the pressure receiving plate 2321 continues this movement, the movable valve 2325 rotates around the rotation shaft 2327 with the contact point between the pressure receiving plate 2321 and the contact portion 2329 as a force point, and the contact point between the rotation shaft 2327 and the casing 231 as a fulcrum. Then the movable valve 2325 moves against the urging force of the spring 2330, and a gap is generated between the orifice 2320 and the movable valve 2325. On the contrary, if the pressure receiving plate 2321 departs from the movable valve 2325 and the urging force of the spring 2330 exceeds the force generated by the pressure difference between the upstream side and the downstream side of the orifice 2320, the movable valve 2325 rotates in the opposite direction and closes the gap. In this way, the movable valve 2325 is configured to open or close the orifice 2320 in link with the operation of the pressure receiving plate 2321.

The direction of the pressure receiving plate 2321, pressing the rotation shaft 2327 when the movable valve 2325 opens, is approximately the opposite of the direction of the spring 2326 urging the pressure receiving plate 2321. In FIG. 10D, L₁ is the distance from the fulcrum to the force point in the direction perpendicular to the pressing direction of the pressure receiving plate 2321, and L₂ is the distance from the fulcrum to a valve center. The valve center is the center of the cross-section of the orifice 2320.

The ink that flows in from the upstream side of the pressure adjustment mechanism 232 flows into the pressure chamber 2323 through the gap between the movable valve 2325 and the orifice 2320, and transfer this pressure to the pressure receiving plate 2321. Then the ink flows out from the downstream side of the pressure adjustment mechanism 232.

In the pressure adjustment mechanism 232 of this embodiment, the pressure inside the pressure chamber 2323 is determined using the following relational expression which indicates the balance of forces applied to each portion. To balance the forces, a leverage principle is applied.

$$( {k}_{d} {x}_{d} + {P}_{2} {S}_{d} ) * {L}_{1} = ( - {k}_{v} {x}_{v} + ( {P}_{{1}^{-}} {P}_{2} ) * {S}_{v} ) * {L}_{2} \qquad ( Expression 1 )$$

L₁: distance from the fulcrum to the force point in the direction perpendicular to the pressing direction of the pressure receiving plate 2321
L₂: distance from the fulcrum to the valve center in the direction perpendicular to the pressing direction of the pressure receiving plate 2321
P₁: ink pressure (pressure difference from atmospheric pressure) on the upstream side of the orifice 2320 (liquid circulation chamber 2324)
P₂: ink pressure (pressure difference from atmospheric pressure) inside the pressure chamber 2323
k_{d}: spring constant of the spring 2326 to urge the pressure receiving plate 2321
x_{d}: spring displacement of the spring 2326 to urge the pressure receiving plate 2321
kᵥ: spring constant of the spring 2330 to urge the movable valve 2325
xᵥ: spring displacement of the spring 2330 to urge the movable valve 2325
S_{d}: pressure receiving area of the pressure receiving portion (pressure receiving plate 2321 and flexible film 2322)
Sᵥ: pressure receiving area of the movable valve 2325

Rearranging (Expression 1), the ink pressure P₂ can be expressed by the following (Expression 2).

$${P}_{2} = ( - {k}_{d} {x}_{d} {L}_{{1}^{-}} {k}_{v} {x}_{v} {L}_{2} + {P}_{1} {S}_{v} {L}_{2} ) / ( {S}_{d} {L}_{1} + {S}_{v} {L}_{2} ) \qquad ( Expression 2 )$$

As the above (Expression 2) indicates, the ink pressure P₂ can be set to a desired control pressure by changing the spring force of the urging members (spring 2326 and spring 2330).

Further, if the valve resistance is R and the flow rate of ink passing through the orifice 2320 is Q, the following (Expression 3) is established.

$${P}_{2} = {P}_{1} - QR \qquad ( Expression 3 )$$

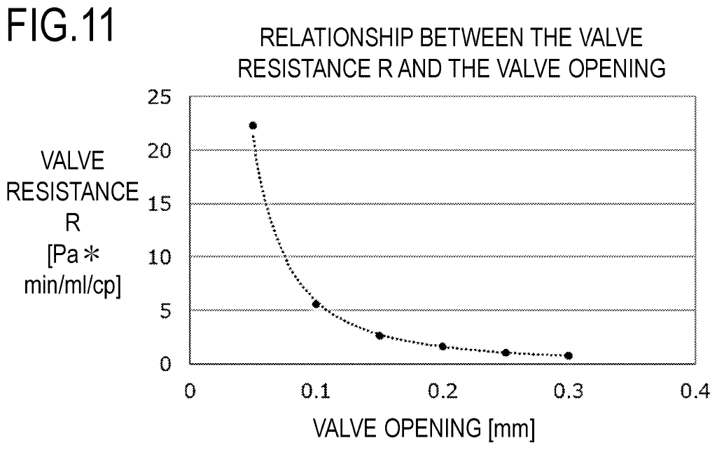

In this embodiment, the orifice 2320 and the movable valve 2325 are configured such that the valve resistance R and the valve opening are in inverse proportion to each other. In other words, if the valve opening increases and the flow rate Q of the ink passing through the orifice 2320 increases, the valve resistance R decreases. FIG. 11 is a graph indicating an example of the relationship between the valve resistance R and the valve opening. In the graph in FIG. 11, the ordinate indicates the valve resistance R [Pa*min/ml/cp], and the abscissa indicates the valve opening [mm]. The ink pressure P₂ is determined by determining the valve position with which (Expression 2) and (Expression 3) are simultaneously established.

As described above, the negative pressure control unit 230 of this embodiment has two pressure adjustment mechanisms 232, of which control pressure values are different from each other. The ink outlet of the first pressure adjustment mechanism 232H of which control pressure is set to a relatively high pressure is connected to the common supply channel 211, and the ink outlet of the second pressure adjustment mechanism 232L of which control pressure is set to a relatively low pressure is connected to the common collection channel 212. In order to prevent the sedimentation of ink which contains a lot of solid components (e.g. pigments) and to implement high image quality printing in this configuration, it is preferable that the flow rate of ink from the common supply channel 211 to the common collection channel 212 is large.

In order to increase this flow rate, it is preferable that the difference between the ink pressure in the common supply channel 211 and the ink pressure of the common collection channel 212 is large, that is, that the difference between the control pressure of the first pressure adjustment mechanism 232H and the control pressure of the second pressure adjustment mechanism 232L is large. The preferable pressure difference between the first pressure adjustment mechanism 232H and the second pressure adjustment mechanism 232L is at least 2000 [Pa], for example. In this embodiment, the negative pressure control unit 230 is configured such that a desired pressure difference can be obtained by differentiating the spring force and the like of the first pressure adjustment mechanism 232H and the second pressure adjustment mechanism 232L.

In the case where the pressure difference is 2000 [Pa] and a channel resistance value inside the recording element substrate 10 is 100 [Pa-min/ml/cP], 2 [cP] of ink can flow at 10 [ml/min], and sedimentation can be prevented thereby. The channel resistance value inside the recording element substrate 10 is a total value of the channel resistance values of the supply path 18, the supply port 17a, the collection port 17b, and the collection path 19 indicated in FIG. 9.

In order to implement even higher quality printing, stabilizing the ejection amount of ink is desirable. The ejection amount of ink may become unstable if the negative pressure at the ejection port 13 becomes excessively high, hence negative pressure at the ejection port 13, to stabilize the ejection amount of ink, is preferably at least −5000 [Pa] (the absolute value is not greater than 5000).

The ink pressure at the ejection port 13 becomes about an average value of the ink pressure in the common supply channel 211 and the ink pressure in the common collection channel 212. As mentioned above, the larger the pressure difference between the common supply channel 211 and the common collection channel 212 the better, but if the negative pressure in the common collection channel 212, controlled to the lower pressure side, is increased too much to increase the pressure difference, the negative pressure at the ejection port 13 may be excessively high. Therefore in this embodiment, the negative pressure control unit 230 is configured such that the ink pressure in the supply path 18 and the supply port 17a of the recording element substrate 10, to supply ink to the ejection port 13 (pressure chamber 23), is controlled to be the positive pressure.

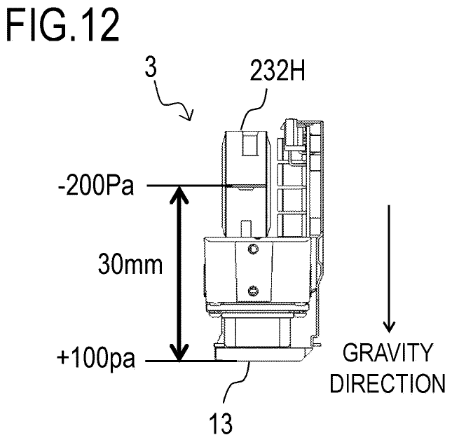

In this embodiment, the first pressure adjustment mechanism 232H, to control the pressure of the ink flowing into the supply path 18 and the supply port 17a, is disposed above the ejection port 13. FIG. 12 is a side view of the liquid ejection head 3 according to this embodiment, and indicates the positional relationship between the first pressure adjustment mechanism 232H and the ejection port 13.

In this embodiment, the liquid ejection head 3 is configured such that the height difference in the gravity direction between the center of the first orifice 2320H of the first pressure adjustment mechanism 232H and the surface on which the ejection port 13 of the recording element substrate 10 is formed becomes 30 [mm]. Since such a configuration is used, the pressure of the ink flowing from the first pressure adjustment mechanism 232H to the ejection port 13 is increased by the height difference between the first pressure adjustment mechanism 232H and the ejection port 13. Specifically, if the pressure control valve of the first pressure adjustment mechanism 232H is −200 [Pa] and the specific gravity of the ink is 1 [g/cm\hat{ }3], the ink pressure in the supply path 18 and the supply port 17a can be controlled to about +100 [Pa] of positive pressure by creating the 30 [mm] of height difference.

As described above, according to the configuration of this embodiment, the negative pressure control unit 230 controls the ink in the supply path 18 to be the positive pressure, and controls the ink in the collection path 19 to be the negative pressure, hence it can prevent the negative pressure of the ink at the ejection port 13 of the recording element substrate 10 from excessively increasing. Further, in this embodiment, the filter 221 is disposed on the upstream side of the negative pressure control unit 230, and no filter is disposed between the negative pressure control unit 230 and the liquid ejection unit 300, hence pressure loss can be reduced, and excessive increase of the negative pressure of the ink at the ejection port 13 can be prevented. Therefore while increasing the flow rate of the ink flowing from the common supply channel 211 to the common collection channel 212, excessive increase of the negative pressure of the ink at the ejection port 13 can be prevented. Moreover, the ink ejection amount can be stabilized while preventing sedimentation and the like of the ink, hence deterioration of the image quality can be prevented.

This embodiment is particularly suitable for the case where a high functional ink, which tends to generate thickening, adhesion and sedimentation, is used for implementing high image quality. Such ink which tends to generate thickening, adhesion and sedimentation is, for example, ink containing titanium oxide or hollow particles, ink of which viscosity is 3 [cp] or more, ink of which moisture ratio is 50% or more, or the like.

In the embodiment described above, the negative pressure control unit 230 is constituted of the pressure adjustment mechanism 232, which is the negative pressure adjustment mechanism, but application of the present invention is not limited to this configuration. For example, out of the two pressure adjustment mechanisms 232, the first pressure adjustment mechanism 232H in which the control pressure is set to relatively high pressure may be used as a positive pressure adjustment mechanism, so that the ink pressure at the outlet of the first pressure adjustment mechanism 232H is controlled to be positive pressure.

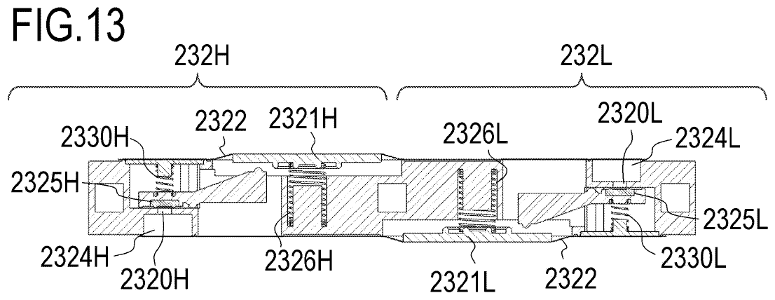

The two pressure adjustment mechanisms 232 may be disposed in one casing so as to face each other. FIG. 13 is a diagram depicting a configuration example of the negative pressure control unit 230. As indicated in FIG. 13, H is attached to a reference sign of each composing element of the first pressure adjustment mechanism 232H, and L is attached to a reference sign of each composing element of the second pressure adjustment mechanism 232L, so as to distinguish each in the description when necessary.

In the configuration example illustrated in FIG. 13, the first pressure adjustment mechanism 232H and the second pressure adjustment mechanism 232L are disposed in point symmetrical to each other. By this positional configuration, the two pressure adjustment mechanisms 232 are disposed in the same casing, so as to be one integrated unit, whereby space can be saved. In this case, a same ink may flow into the two pressure adjustment mechanisms 232, or the two pressure adjustment mechanisms 232 may be controlled to be different pressure values. In the case of controlling to be different pressure values, one of the two pressure adjustment mechanisms 232 may be fluidly connected to the upstream side of the ejection nozzle, and the other to the downstream side thereof. Then the ink inside the injection nozzle can be circulated, and the adhesion of ink in the ejection nozzle can be prevented.

In the embodiment described above, in the pressure adjustment mechanism 232, a coupling spring, constituted of the spring 2326 and the spring 2330, is disposed as the urging means, but application of the present invention is not limited to this configuration. If the urging force of one spring is sufficient to control the ink pressure to be a desired negative pressure in the pressure adjustment mechanism 232, only one of the springs 2326 and 2330 may be disposed.

### Configuration Example of Negative Pressure Control Unit

In the embodiment described above, different control pressure values are set for the first pressure adjustment mechanism 232H and the second pressure adjustment mechanism 232L of the negative pressure control unit 230. Specific configuration examples, to generate a pressure difference between the first pressure adjustment mechanism 232H and the second pressure adjustment mechanism 232L, will be described below.

### First Configuration Example

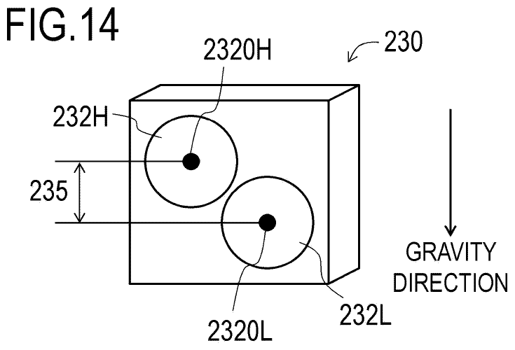

A first configuration example, to generate the pressure difference using a water head difference, will be described first. FIG. 14 is an explanatory diagram of the negative pressure control unit 230 of the first configuration example. In the first configuration example, the first orifice 2320H of the first pressure adjustment mechanism 232H and the second orifice 2320L of the second pressure adjustment mechanism 232L are disposed in positions shifted in the gravity direction. Because of this configuration, the distance between the first orifice 2320H of the first pressure adjustment mechanism 232H and the ejection port 13 in the gravity direction and the distance between the second orifice 2320L of the second pressure adjustment mechanism 232L, and the ejection port 13 in the gravity direction have a difference 235. In the first configuration example, the first pressure adjustment mechanism 232H is disposed above the second pressure adjustment mechanism 232L. The value of the difference 235 can be appropriately determined in accordance with the pressure difference to be generated.

In the first configuration example, the pressure difference can be generated more accurately using the difference 235, which can reduce the factors that fluctuate the pressure difference. This configuration is particularly suitable in a case where there are sufficient spaces in the liquid ejection head 3 or the recording device 1000 in the gravity direction, and accurate control of the pressure difference is desired.

### Second Configuration Example

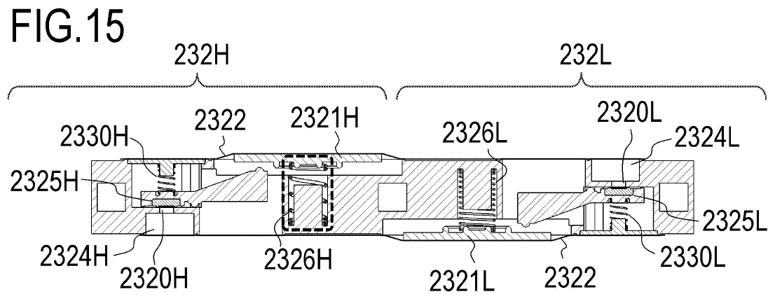

A second configuration example, to generate the pressure difference by differentiating the spring constant of each of the pressure adjustment mechanisms 232, will be described next. FIG. 15 is an explanatory diagram of the negative pressure control unit 230 of the second configuration example. In the second configuration example, the spring constant k_{d} of the spring 2330H of the first pressure adjustment mechanism 232H and the spring constant k_{d} of the spring 2330L of the second pressure adjustment mechanism 232L are set to different values.

As indicated in (Expression 2) described above, if the spring constant k_{d} changes, the urging force to urge the pressure receiving plate 2321 changes, and the ink pressure P₂ changes. Therefore in the second configuration example, the spring constant k_{d} of the first pressure adjustment mechanism 232H and that of the second pressure adjustment mechanism 232L are differentiated to generate the pressure difference. Because of this configuration, the urging force for the spring (first urging member) 2326H to urge the first movable valve 2325H and the urging force for the spring (second urging member) 2326L to urge the second movable valve 2325L become different, and the pressure difference can be generated thereby. Further, according to this configuration, the first pressure adjustment mechanism 232H and the second pressure adjustment mechanism 232L can share all the components other than the springs 2330.

A specific example will be described. When the ink pressure P₂ (pressure difference from atmospheric pressure) inside the pressure chamber 2323 is −3000 [Pa] in (Expression 2), and the spring constant k_{d} here is a spring constant k_{d1}, the following (Expression 4) is established.

$$- 3000 = ( - {k}_{d 1} {x}_{d} {L}_{1} - {k}_{v} {x}_{v} {L}_{2} + {P}_{1} {S}_{v} {L}_{2} ) / ( {S}_{d} {L}_{1} + {S}_{v} {L}_{2} ) \qquad ( Expression 4 )$$

Rearranging (Expression 4), k_{d1} can be expressed by the following (Expression 5)

$${k}_{d 1} = - ( - 30 \; 00 ( {S}_{d} {L}_{1} + {S}_{v} {L}_{2} ) + {k}_{v} {x}_{v} {L}_{2} - {P}_{1} {S}_{v} {L}_{2} ) / {x}_{d} {L}_{1} \qquad ( Expression 5 )$$

On the other hand, when the ink pressure P₂ (pressure difference from atmospheric pressure) inside the pressure chamber 2323 is −5000 [Pa], and the spring constant k_{d} here is a spring constant k_{d2}, k_{d2} is expressed by the following (Expression 6).

$${k}_{d 2} = - ( - 5 \; 000 ( {S}_{d} {L}_{1} + {S}_{v} {L}_{2} ) + {k}_{v} {x}_{v} {L}_{{2}^{-}} {P}_{1} {S}_{v} {L}_{2} ) / {x}_{d} {L}_{1} \qquad ( Expression 6 )$$

As indicated in (Expression 5) and (Expression 6), the ink pressure P₂ of each of the pressure adjustment mechanisms 232 can be adjusted by changing the spring constant k_{d}. In other words, a desired pressure difference can be generated by using the spring 2330 having an appropriate spring constant k_{d} according to the control pressure for each of the first pressure adjustment mechanism 232H and the second pressure adjustment mechanism 232L respectively. For example, it is preferable to select each spring constant k_{d} such that the urging force by the spring 2326H of the first pressure adjustment mechanism 232H, of which control pressure is relatively high, becomes smaller than the urging force by the spring 2326L of the second pressure adjustment mechanism 232L, of which control pressure is relatively low.

In the second configuration example, the spring constants k_{d} of the springs 2330 of the two pressure adjustment mechanisms 232 are differentiated, but the spring constants kᵥ of the spring 2326 thereof may be differentiated, or both the spring constants k_{d} and the spring constants kᵥ thereof may be differentiated. A method for changing the spring constant is to use a spring having a different number of turns, or a spring formed of a different material, for example, but this method is not especially limited.

### Third Configuration Example

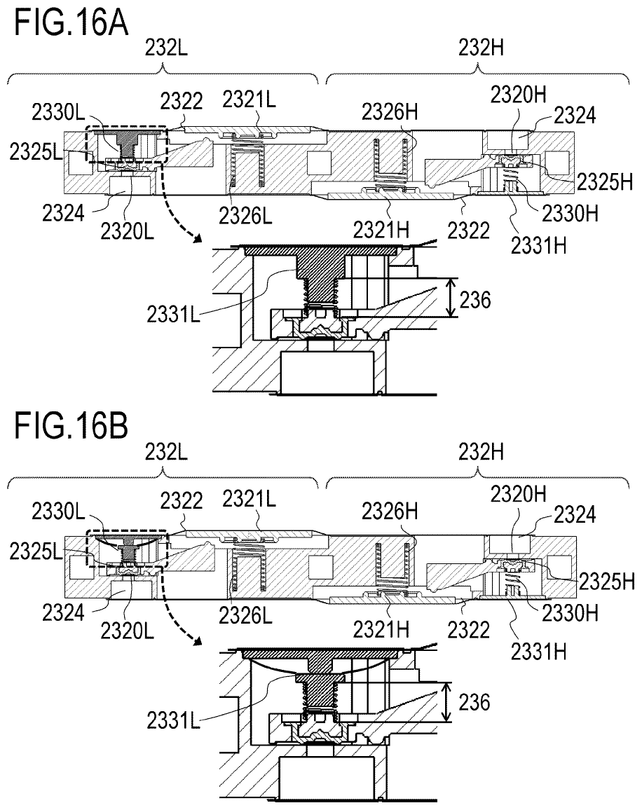

A third configuration example to generate the pressure difference by differentiating the spring storing length of each of the pressure adjustment mechanisms 232 will be described next. FIGS. 16A and 16B are explanatory diagrams of the negative pressure control unit 230 of the third configuration example. In the third configuration example, the spring storing length of the spring 2326H of the first pressure adjustment mechanism 232H and the spring storing length of the spring 2326L of the second pressure adjustment mechanism 232L are set to different lengths.

The spring storing length is a length from one end to the other end of the spring in a state where the movable valve 2325 is closed. If identical springs are used, the urging force of the spring increases when the spring storing length is shorter compared with the configuration where the spring storing length is longer, since the spring displacement increases.

FIG. 16A indicates a structure of the negative pressure control unit 230 according to the third configuration example, and an enlarged view of a spring storing portion of the second pressure adjustment mechanism 232L. In the first pressure adjustment mechanism 232H of the third configuration example, a spring holder 2331H is disposed, and one end of the spring 2326H is supported by the spring holder 2331H. In the same manner, in the second pressure adjustment mechanism 232L, a spring holder 2331L is disposed, and one end of the spring 2326L is supported by the spring holder 2331L. In other words, the spring storing length of the spring 2326L is the same as the length from the spring support surface of the spring holder 2331 to the spring support surface of the second movable valve 2325L. In the same manner, the spring storing length of the spring 2326L is the same as the length from the spring support surface of the spring holder 2331 to the spring support surface of the second movable valve 2325L. Further, the spring storing length of the spring 2330 is the same as the length from the spring support surface of the pressure receiving plate 2321 to the spring support surface of the casing 231 in a state where the movable valve 2325 is closed.

In the third configuration example, the spring holders 2331H and 2331L are configured such that the spring storing length 236 in the second pressure adjustment mechanism 232L is different from the spring storing length in the first pressure adjustment mechanism 232H. Because of this configuration, the urging force for the spring (first urging member) 2326H to urge the first movable valve 2325H, and the urging force for the spring (second urging member) 2326L to urge the second movable valve 2325L, become different, and the pressure difference can be generated thereby. By using this configuration, more accurate pressure control can be performed, so the ink circulation flow speed in the ejection port can be more accurately adjusted with generating the desired pressure difference. For example, it is preferable to select the spring storing lengths such that the urging force by the spring 2330H of the first pressure adjustment mechanism 232H of which control pressure is relatively high becomes smaller than the urging force by the spring 2330L of the second pressure adjustment mechanism 232L of which control pressure is relatively low.

FIG. 16B indicates a structure of the negative pressure control unit 230 according to a modification of the third configuration example, and an enlarged view of the spring storing portion of the second pressure adjustment mechanism 232L. In the configuration to generate the pressure difference by changing the spring storing length, it is preferable that the spring holder 2331 is constituted of a plurality of components, and can adjust the spring storing length.

In the third configuration example, the spring storing lengths of the springs 2326 of the two pressure adjustment mechanisms 232 are differentiated, but the spring storing lengths of the springs 2330 may be differentiated, or both the spring storing lengths of the springs 2326 and the springs 2330 may be differentiated. Because of this configuration, the control pressure can be adjusted after the negative pressure control unit 230 is assembled. Further, a more accurate pressure control can be performed, so the ink circulation flow speed in the ejection port can be more accurately adjusted with generating the desired pressure difference.

### Fourth Configuration Example

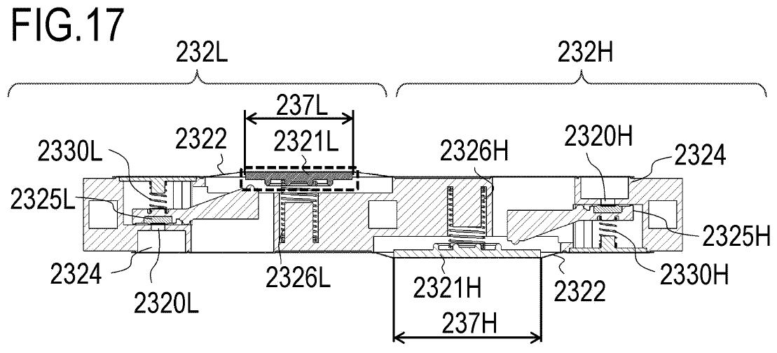

A fourth configuration example, to generate the pressure difference by differentiating the pressure receiving area S_{d} of each pressure receiving portion (pressure receiving plate 2321 and flexible film 2322) of each of the pressure adjustment mechanisms 232, will be described. FIG. 17 is an explanatory diagram of the negative pressure control unit 230 of the fourth configuration example. In the fourth configuration example, a diameter 237H of the first pressure receiving plate 2321H of the first pressure adjustment mechanism 232H and a diameter 237L of a second pressure receiving plate 2321L of the second pressure adjustment mechanism 232L are set to different lengths. The first pressure receiving plate 2321H and the second pressure receiving plate 2321L are approximately disk-shaped, and have pressure receiving areas different from each other.

If the pressure receiving area S_{d} of the pressure receiving portion is adjusted by differentiating the diameter 237H of the first pressure receiving plate 2321H and the diameter 237L of the second pressure receiving plate 2321L, as described in the fourth configuration example, the ink pressure P₂ of each of the pressure adjustment mechanisms 232 can be adjusted. For example, it is preferable to set such that the pressure receiving area of the first pressure receiving plate 2321H of the first pressure adjustment mechanism 232H of which control pressure is relatively high becomes larger than the pressure receiving area of the second pressure receiving plate 2321L of the second pressure adjustment mechanism 232L of which control pressure is relatively low. Further, by increasing the pressure receiving area of the pressure receiving plate 2321, the influence of fluctuation of the ink pressure P₁ applied from the orifice 2320 side can be reduced.

In the fourth configuration example, the flexible film 2322 is disposed to seal the gap between the pressure receiving plate 2321 and the casing 231, but application of the present invention is not limited to this configuration. A seal configuration, other than the flexible film 2322, may be used for the pressure adjustment mechanism 232 if the gap can be fluidly sealed and operation of the pressure receiving plate 2321 and the open/close operation of the movable valve 2325 are not interrupted thereby.

### Fifth Configuration Example

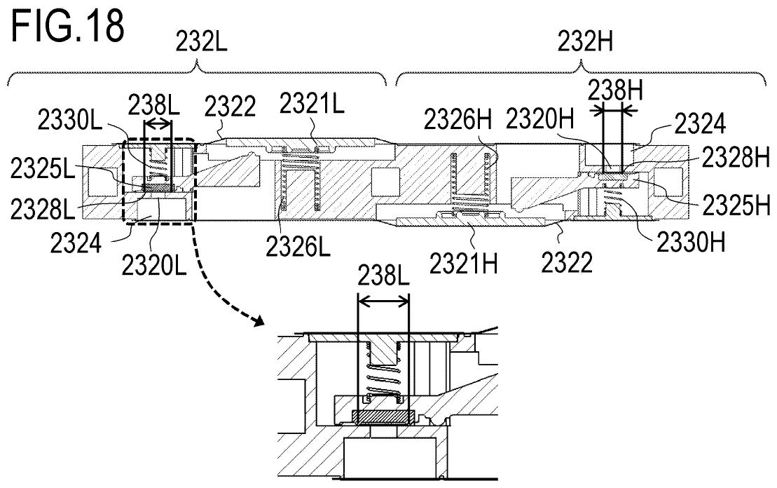

A fifth configuration example, to generate the pressure difference by differentiating the pressure receiving area Sᵥ of the movable valve 2325 of each of the pressure adjustment mechanisms 232, will be described. FIG. 18 is an explanatory diagram of the negative pressure control unit 230 of the fifth configuration example, and indicates the structure of the negative pressure control unit 230, and an enlarged view of the area near the second orifice 2320L of the second pressure adjustment mechanism 232L. In a state where the movable valve 2325 is closed, the inner portion of the contact portion between the movable valve 2325 and the casing 231 (portion enclosed by the closing portion 2328 of the movable valve 2325) is approximately circular, and receives pressure from the side of the liquid circulation chamber 2324. In the following description, the diameter of the portion which receives pressure from the side of the liquid circulation chamber 2324 of the movable valve 2325 is regarded as a pressure receiving diameter 238. In the fifth configuration example, the pressure receiving diameter 238H of the first movable valve 2325H of the first pressure adjustment mechanism 232H and the pressure receiving diameter 238L of the second movable valve 2325L of the second pressure adjustment mechanism 232L are set to different lengths.

If the pressure receiving area Sᵥ of the movable valve 2325 is adjusted by differentiating the pressure receiving diameter 238H of the first movable valve 2325H and the pressure receiving diameter 238L of the second movable valve 2325L, as described in the fifth configuration example, the ink pressure P₂ of each of the pressure adjustment mechanisms 232 can be adjusted. For example, if the pressure receiving diameters 238 of the movable valve 2325 is decreased, the size of the negative pressure control unit 230 can be decreased. However, if the pressure receiving area Sᵥ of the movable valve 2325 is excessively decreased, the valve resistance more easily fluctuates because of the inclination of the movable valve 2325, which may make the control pressure unstable. Hence it is preferable to set the pressure receiving area Sᵥ considering the size of the negative pressure control unit 230 and the stability of the control pressure.

In the fifth configuration example, the pressure receiving portion of the movable valve 2325 is approximately a circular plane, but application of the present invention is not limited to this configuration. By changing various dimensions such that the pressure receiving area Sᵥ is adjusted in accordance with the shape of the pressure receiving portion of the movable valve 2325, the ink pressure P₂ of the pressure adjustment mechanism 232 can be adjusted to a desired pressure.

As described in the first to fifth configuration examples, by changing the arrangement positions and the dimensions of a part of the components in the two pressure adjustment mechanisms 232, the control pressures of the two pressure adjustment mechanisms 232 can be differentiated. Further, according to the first to fifth configuration examples, many components can be shared by the first pressure adjustment mechanism 232H and the second pressure adjustment mechanism 232L, hence a number of components used for the negative pressure control unit 230 can be decreased, which leads to cost reduction. Particularly in the case of the second configuration example, where only the springs 2326 are not shared by the first pressure adjustment mechanism 232H and the second pressure adjustment mechanism 232L, the only components to be increased are the springs 2326, which are not required dies for molding. This can reduce a cost increase more effectively.

The first to fifth configuration examples may be combined instead of being implemented independently. For example, the second configuration example and the fourth configuration example may be combined, using a dedicated spring 2326 and pressure receiving plate 2321 respectively for the first pressure adjustment mechanism 232H and the second pressure adjustment mechanism 232L. By combining each configuration example, the control range of the ink pressure in each of the pressure adjustment mechanisms 232 can be expanded.

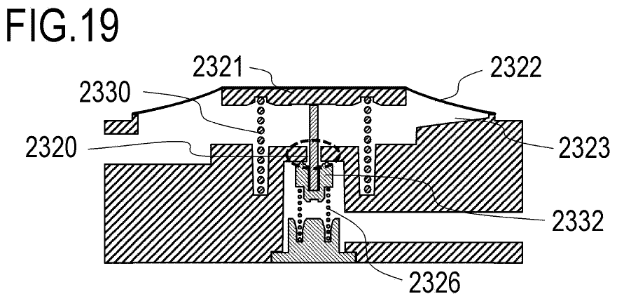

In the above mentioned embodiment and each configuration example, the negative pressure control unit 230 is constituted of the movable valve 2325, which is a lever valve, but application of the present invention is not limited to this configuration. For example, in the pressure adjustment mechanisms 232 of the negative pressure control unit 230, a direct-driven type valve 2332, which is configured to be movable in parallel, may be disposed instead of the movable valve 2325. FIG. 19 is a diagram depicting the pressure adjustment mechanism 232 according to the modification, and indicates the configuration of the pressure adjustment mechanism 232 which includes the direct-driven type valve 2332.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-113159, filed on Jul. 10, 2023, which is hereby incorporated by reference herein in its entirety.

What is claimed is:

1. A liquid ejection head comprising:
a recording element substrate including an ejection port, an energy generation element which generates energy to eject liquid from the ejection port, a supply path which supplies liquid to the ejection port, and a collection path which collects liquid not ejected from the ejection port; and
a pressure control unit controlling pressure of liquid inside the supply path to be positive pressure and pressure of liquid inside the collection path to be negative pressure so that pressure of liquid in the ejection port becomes negative pressure.

2. The liquid ejection head according to claim 1,
wherein the pressure control unit controls respective pressure so that a difference between the pressure of liquid inside the supply path and the pressure of liquid inside the collection path becomes at least 2000 [Pa].

3. The liquid ejection head according to claim 2,
wherein channel resistance values of the supply path and the collection path are not more than 100 [Pa*min/ml/cP].

4. The liquid ejection head according to claim 1,
wherein the pressure control unit controls the pressure of liquid inside the supply path and the pressure of liquid inside the collection path so that the negative pressure of liquid in the ejection port becomes at least −5000 [Pa].

5. The liquid ejection head according to claim 1,
wherein the pressure control unit is located above the ejection port, and includes a first pressure adjustment mechanism that adjusts pressure of liquid to negative pressure and sends the liquid to the supply path, and a second pressure adjustment mechanism that adjusts pressure of liquid to negative pressure and sends the liquid to the collection path.

6. The liquid ejection head according to claim 5,
wherein the first pressure adjustment mechanism includes an orifice and a movable valve configured to allow the orifice to open or close, and
wherein a height difference between a center of the orifice and a surface on which the ejection port is formed is at least 30 [mm].

7. The liquid ejection head according to claim 5,
wherein the first pressure adjustment mechanism and the second pressure adjustment mechanism are disposed at shifted positions in a gravity direction.

8. The liquid ejection head according to claim 5,
wherein the first pressure adjustment mechanism includes a first orifice, a first pressure receiving plate configured to be movable by a pressure difference between inside and outside the first pressure adjustment mechanism, and a first movable valve configured to allow the first orifice to open or close linking with operation of the first pressure receiving plate, and
wherein the second pressure adjustment mechanism includes a second orifice, a second pressure receiving plate configured to be movable by a pressure difference between inside and outside the second pressure adjustment mechanism, and a second movable valve configured to allow the second orifice to open or close linking with operation of the second pressure receiving plate.

9. The liquid ejection head according to claim 8,
wherein the first movable valve is configured to be movable from a position to close the first orifice to a position to open the first orifice by being pressed by the first pressure receiving plate,
wherein the first pressure adjustment mechanism includes a first urging member that urges the first pressure receiving plate in a direction away from the first movable valve,
wherein the second movable valve is configured to be movable from a position to close the second orifice to a position to open the second orifice by being pressed by the second pressure receiving plate,
wherein the second pressure adjustment mechanism includes a second urging member that urges the second pressure receiving plate in a direction away from the second movable valve, and
wherein an urging force of the first urging member is smaller than an urging force of the second urging member.

10. The liquid ejection head according to claim 8,
wherein the first pressure adjustment mechanism includes a first urging member that urges the first movable valve in a direction to move the first movable valve from a position to open the first orifice to a position to close the first orifice,
wherein the second pressure adjustment mechanism includes a second urging member that urges the second movable valve in a direction to move the second movable valve from a position to open the second orifice to a position to close the second orifice, and
wherein an urging force of the first urging member is smaller than an urging force of the second urging member.

11. The liquid ejection head according to claim 8,
wherein a pressure receiving area of the first pressure receiving plate is larger than a pressure receiving area of the second pressure receiving plate.

12. The liquid ejection head according to claim 8,
wherein an area of a pressure receiving portion in which the first movable valve receives pressure from the first orifice side is different from an area of a pressure receiving portion in which the second movable valve receives pressure from the second orifice side.

13. The liquid ejection head according to claim 1,
wherein liquid of which pressure is controlled by the pressure control unit contains titanium oxide or hollow particles.

14. The liquid ejection head according to claim 1,
wherein viscosity of liquid of which pressure is controlled by the pressure control unit is at least 3 [cp].

15. The liquid ejection head according to claim 1,
wherein a moisture ratio of liquid of which pressure is controlled by the pressure control unit is at least 50%.

16. A recording device comprising:
a liquid ejection head equipped with a recording element substrate including an ejection port, an energy generation element which generates energy to eject liquid from the ejection port, a supply path which supplies liquid to the ejection port, and a collection path which collects liquid not ejected from the ejection port; and
a pressure control unit controlling pressure of liquid inside the supply path to be positive pressure and pressure of liquid inside the collection path to be negative pressure so that pressure of liquid in the ejection port becomes negative pressure.

17. The recording device according to claim 16,
wherein the pressure control unit controls respective pressure so that a difference between the pressure of liquid inside the supply path and the pressure of liquid inside the collection path become at least 2000 [Pa].

18. The recording device according to claim 16,
wherein the pressure control unit controls the pressure of liquid inside the supply path and the pressure of liquid inside the collection path so that the negative pressure of liquid in the ejection port becomes at least −5000 [Pa].

19. The recording device according to claim 16,
wherein the pressure control unit is located above the ejection port, and includes a first pressure adjustment mechanism that adjusts pressure of liquid to negative pressure and sends the liquid to the supply path, and a second pressure adjustment mechanism that adjusts pressure of liquid to negative pressure and sends the liquid to the collection path.
